(19) United States
(12) Patent Application Publication
(10) Pub. No.: US 2014/0229847 A1
(43) Pub. Date: Aug. 14, 2014

(54) INPUT INTERFACE CONTROLLING APPARATUS AND METHOD THEREOF

(71) Applicant: Jihwan Park, Changwon-si (KR)

(72) Inventor: Jihwan Park, Changwon-si (KR)

(73) Assignee: LG ELECTRONICS INC., Seoul (KR)

(21) Appl. No.: 14/343,267

(22) PCT Filed: Oct. 13, 2011
(86) PCT No.: PCT/KR2011/007610

§ 371 Date: Mar. 6, 2014

(51) Int. Cl. G06F 3/0488; G06F 3/0481

(52) U.S. Cl. CPC G06F 3/04886; G06F 3/0481
USPC 715/744

(57) ABSTRACT

A type of an input interface of a second terminal (e.g., a mobile communication terminal) is changed according to an application of a first terminal (e.g., a vehicle terminal, an electronic device such as a television, or the like), so the user can easily input or select (or execute) data through the changed input interface. An input interface controlling apparatus includes: a display unit; a communication unit configured to form a wireless communication network with an external terminal when an icon for executing an input interface displayed on the display unit is selected; and a controller configured to select a type of the input interface according to an application executed in the external terminal, and display an input interface of the selected type on the display unit.

### TECHNICAL FIELD

The present invention relates to an input interface controlling apparatus of a mobile terminal and a method thereof.

### BACKGROUND ART

In general, a mobile communication terminal includes a standard Qwerty keyboard, and it is applied to a virtual keyboard displayed on the a display screen. The virtual keyboard is generally implemented as a touch screen keyboard. A related art of the keyboard is disclosed in Korean Patent Application No. 10-2010-7017144.

### DISCLOSURE OF INVENTION

### Solution to Problem

An aspect of the present invention provides input interface controlling apparatus and method capable of changing (determining or selecting) a type of an input interface of a second terminal (e.g., a mobile communication terminal) according to an application of a first terminal (e.g., a vehicle terminal, an electronic device such as a television, or the like) to thus allow a user to easily input or select (or execute) data through the changed input interface.

According to an aspect of the present invention, there is provided an input interface controlling apparatus, including: a display unit; a communication unit configured to form a wireless communication network with an external terminal when an icon for executing an input interface displayed on the display unit is selected; and a controller configured to select a type of the input interface according to an application executed in the external terminal, and display an input interface of the selected type on the display unit.

The controller may select any one of a virtual keyboard, a virtual keypad, and a touch pad, as the input interface based on the application executed in the external terminal.

The controller may receive a request for an input interface interworking with the application from the external terminal through the wireless communication network, select the input interface interworking with the application according to the received input interface request, and apply the selected input interface to the display unit.

The controller may select a type of the input interface based on a type of an input window displayed on the external terminal by the application.

The controller may control the application according to an input of the selected input interface.

The controller may display an input window along with the input interface on the display unit, and when a key of the input interface is selected, the controller may display key information corresponding to the selected key on the input window.

The controller may receive a search word or a related word associated with the key information from the external terminal through the wireless communication network, and display the received search word or the related word in the input window.

When a Web browser or a map application is executed in the external terminal, the controller may automatically display a touch pad or a virtual keyboard on the display unit.

When a number input window is displayed on the external terminal, the controller may select a number keypad or a keyboard displaying only numbers, and display the selected number keypad or the keyboard displaying only numbers.

When the application is executed in the external terminal, the controller may automatically select a virtual keyboard or a touch pad for controlling the application, and apply the selected virtual keyboard or the touch pad as the input interface on the display unit.

According to another aspect of the present invention, there is provided a method for controlling an input interface, including: when an icon for executing a input interface displayed on a display unit, forming a wireless communication network with an external terminal; selecting a type of the input interface according to an application executed in the external terminal; and displaying the selected type of the input interface on the display unit.

In the apparatus for controlling an input interface of a mobile terminal and the method thereof according to embodiments of the present invention, since a type of an input interface of a second terminal (e.g., a mobile communication terminal) is changed according to an application of a first terminal (e.g., a vehicle terminal, an electronic device such as a television, or the like), the user can easily input or select (or execute) data through the changed input interface.

In the apparatus for controlling an input interface of a mobile terminal and the method thereof according to embodiments of the present invention, the input interface of the second terminal (e.g., a mobile communication terminal) is displayed according to an application of the first terminal (e.g., a vehicle terminal, an electronic device such as a television, or the like), and when a particular key of the displayed input interface is selected, a search word, a recommended word, or the like, related to the selected particular key is detected and displayed, the user can quickly and easily input keys.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view showing the configuration of a mobile communication terminal employing an input interface controlling apparatus according to embodiments of the present invention;

FIG. 2 is a view showing the configuration of a telematics terminal employing the input interface controlling apparatus according to embodiments of the present invention;

FIG. 3 is a view showing the configuration of an input interface controlling apparatus according to an embodiment of the present invention;

FIG. 4 is a flow chart illustrating a process of a method for controlling an input interface according to an embodiment of the present invention;

FIG. 5 is a flow chart illustrating a process of a method for controlling an input interface according to another embodiment of the present invention;

FIG. 6 is a view showing an input interface controlling apparatus and a television according to another embodiment of the present invention;

FIG. 7 is a flow chart illustrating a process of a method for controlling an input interface according to another embodiment of the present invention;

FIG. 8 is a view showing an input interface controlling apparatus and a vehicle terminal according to another embodiment of the present invention;

FIG. 9 is a view showing information regarding a point of interest (POI) displayed on the vehicle terminal according to another embodiment of the present invention; and

FIG. 10 is a view showing the POI search results displayed on the vehicle terminal according to another embodiment of the present invention.

### BEST MODE FOR CARRYING OUT THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

The exemplary embodiments of the present invention will now be described with reference to the accompanying drawings, in which like numbers refer to like elements throughout.

In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings. The technical idea of the present invention should be interpreted to embrace all such alterations, modifications, and variations in addition to the accompanying drawings.

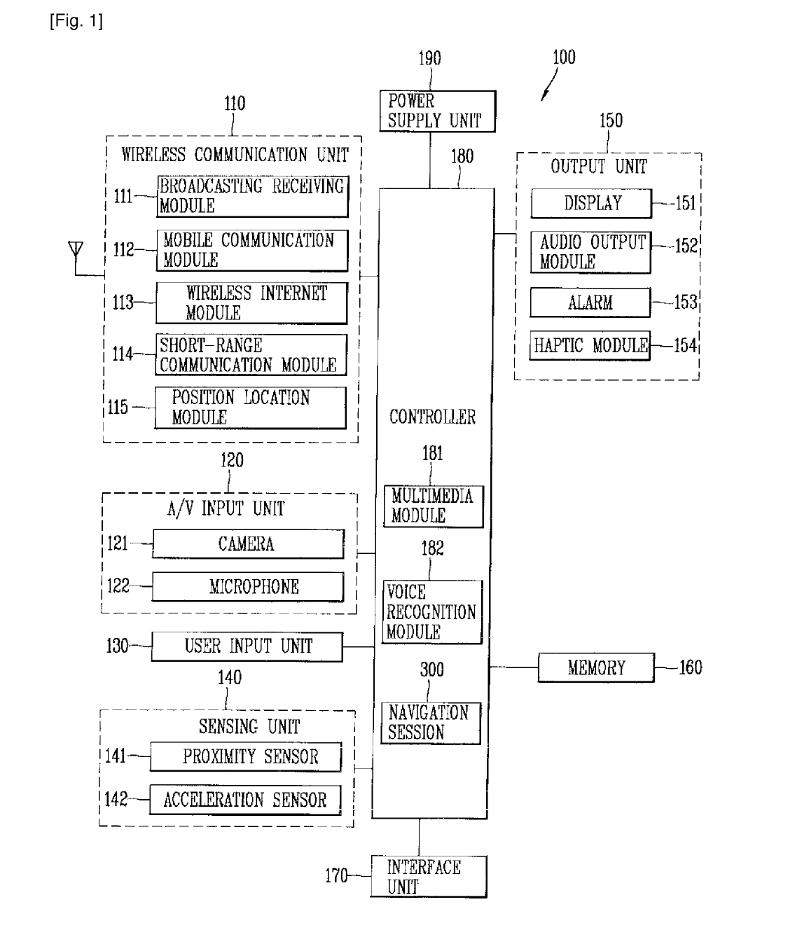

FIG. 1 is a view showing the configuration of a mobile communication terminal employing an input interface controlling apparatus according to embodiments of the present invention. A mobile communication terminal (or a mobile phone) 100 may be implemented in various forms such as mobile phones, smart phones, notebook computers, digital broadcast terminals, PDAs (Personal Digital Assistants), PMPs (Portable Multimedia Player), etc.

As shown in FIG. 1, the mobile communication terminal 100 includes a wireless communication unit 110, an AN (Audio/Video) input unit 120, a user input unit 130, a sensing unit 140, an output unit 150, a memory 160, an interface unit 170, a controller 180, and a power supply unit 190, etc. FIG. 1 shows the mobile communication terminal 100 having various components, but it is understood that implementing all of the illustrated components is not a requirement. The mobile communication terminal 100 may be implemented by greater or fewer components.

The wireless communication unit 110 typically includes one or more components allowing radio communication between the mobile communication terminal 100 and a wireless communication system or a network in which the mobile communication terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast associated information may refer to information associated with a broadcast channel, a broadcast program or a broadcast service provider. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile communication terminal. This module may be internally or externally coupled to the terminal. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile communication terminal (when the mobile communication terminal is located in a vehicle, the location of the vehicle can be checked). For example, the location information module 115 may be embodied by using a GPS (Global Positioning System) module that receives location information from a plurality of satellites. Here, the location information may include coordinate information represented by latitude and longitude values. For example, the GPS module may measure an accurate time and distance from three or more satellites, and accurately calculate a current location of the mobile communication terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. As the location information module 115, a Wi-Fi position system and/or a hybrid positioning system may be used.

The A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capturing device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile communication terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile communication terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 (or other detection means) detects a current status (or state) of the mobile communication terminal 100 such as an opened or closed state of the mobile communication terminal 100, a location of the mobile communication terminal 100, the presence or absence of user contact with the mobile communication terminal 100 (i.e., touch inputs), the orientation of the mobile communication terminal 100, an acceleration or deceleration movement and direction of the mobile communication terminal 100, etc., and generates commands or signals for controlling the operation of the mobile communication terminal 100. For example, when the mobile communication terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The interface unit 170 (or other connection means) serves as an interface by which at least one external device may be connected with the mobile communication terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. Here, the identification module may be a memory chip (or other element with memory or storage capabilities) that stores various information for authenticating user s authority for using the mobile communication terminal 100 and may include a user identity module (UIM), a subscriber identity module (SIM) a universal subscriber identity module (USIM), and the like. In addition, the device having the identification module (referred to as the identifying device, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile communication terminal 100 or may be used to transfer data within the mobile communication terminal to an external device.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. The mobile terminal 100 may include two or more display units (or other display means) according to its particular desired embodiment. For example, the mobile terminal may include both an external display unit (not shown) and an internal display unit (not shown).

When the display unit 151 and the touch pad are overlaid in a layered manner to form a touch screen, the display unit 151 may function as both an input device and an output device. The touch sensor may have the form of, for example, a touch film, a touch sheet, a touch pad, and the like.

The touch sensor may be configured to convert the pressure applied to a particular portion of the display unit 151 or a change in capacitance generated at a particular portion of the display unit 151 into an electrical input signal. The touch sensor may be configured to detect a touch input pressure as well as a touch input position and a touch input area. When there is a touch input with respect to the touch sensor, the corresponding signal(s) are sent to a touch controller (not shown). The touch controller processes the signal(s) and transmits corresponding data to the controller 180. Accordingly, the controller 180 can recognize a touched region of the display unit 151.

Proximity touch in the present exemplary embodiment refers to recognition of the pointer positioned to be close to the touch screen without being in contact with the touch screen.

A proximity sensor 141 may be may be disposed within the mobile terminal covered by the touch screen or near the touch screen. The proximity sensor 141 refers to a sensor for detecting the presence or absence of an object that accesses a certain detect surface or an object that exists nearby by using the force of electromagnetism or infrared rays without a mechanical contact. Thus, the proximity sensor 141 has a longer life span compared with a contact type sensor, and it can be utilized for various purposes.

The example of the proximity sensor 141 may be a transmission type photo sensor, a direct reflection type photo sensor, a mirror-reflection type photo sensor, an RF oscillation type proximity sensor, a capacitance type proximity sensor, a magnetic proximity sensor, an infrared proximity sensor. When the touch screen is an electrostatic type touch screen, an approach of the pointer is detected based on a change in an electric field according to the approach of the pointer. In this case, the touch screen (touch sensor) may be classified as a proximity sensor.

In the following description, for the sake of brevity, recognition of the pointer positioned to be close to the touch screen without being contacted will be called a proximity touch, while recognition of actual contacting of the pointer on the touch screen will be called a contact touch. In this case, when the pointer is in the state of the proximity touch, it means that the pointer is positioned to correspond vertically to the touch screen.

The proximity sensor 141 detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The sensing unit 140 may include an acceleration sensor 142. The acceleration sensor 142, an element for converting a change in acceleration in one direction into an electrical signal, is widely used in line with the development of a micro-electromechanical system (MEMS) technique. The acceleration sensor 142 includes various types of sensors: an acceleration sensor installed in an air-bag system of a vehicle to measure a great value of acceleration used for detecting a collision, an acceleration sensor for recognizing a fine operation of a user s hand so as to be used as an input unit for games, or the like. The acceleration sensor 142 is configured such that two axes or three axes are mounted on a single package, and only a Z axis may be required according to a usage environment. Thus, when an X-axis directional acceleration sensor or a Y-axis directional acceleration sensor is to be used for a certain reason, a separate piece substrate may be used and the acceleration sensor may be mounted on a main substrate.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed in the mobile terminal 100. The audio output module 152 may include a receiver, a speaker, a buzzer, etc.

The alarm unit 153 outputs a signal for informing about an occurrence of an event of the mobile terminal 100. Events generated in the mobile terminal may include call signal reception, message reception, key signal inputs, and the like. In addition to video or audio signals, the alarm unit 153 may output signals in a different manner, for example, to inform about an occurrence of an event. For example, the alarm unit 153 may output a signal in the form of vibration. When a call signal is received or a message is received, the alarm unit 153 may vibrate the mobile terminal through a vibration means. Or, when a key signal is inputted, the alarm unit 153 may vibrate the mobile terminal 100 through a vibration means as a feedback with respect to the key signal input. Through the vibration, the user may recognize the occurrence of an event. A signal for notifying about the occurrence of an event may be output to the display unit 151 or to the voice output module 152.

A haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100. The haptic module 154 may be provided to a place which is frequently in contact with the user. For example, the haptic module 154 may be provided to a steering wheel, a gearshift, a lever, a seat, and the like.

The memory 160 may store software programs used for the processing and controlling operations performed by the controller 180, or may temporarily store data (e.g., a map data, phonebook, messages, still images, video, etc.) that are inputted or outputted.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like. Here, the identification module may be a chip that stores various types of information for authenticating the authority of using the mobile terminal 100 and may include a user identity module (UIM), a subscriber identity module (SIM) a universal subscriber identity module (USIM), and the like. In addition, the device having the identification module (referred to as identifying device, hereinafter) may take the form of a smart card. Accordingly, the identifying device may be connected with the terminal 100 via a port. The interface unit 170 may be used to receive inputs (e.g., data, information, power, etc.) from an external device and transfer the received inputs to one or more elements within the mobile terminal 100 or may be used to transfer data between the mobile terminal and an external device.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof. For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself. For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

The voice recognition module 182 recognizes a voice pronounced by the user and performs a corresponding function according to the recognized voice signal.

A navigation session 300 applied to the mobile terminal 100 displays a travel route on map data.

Meanwhile, an input interface controlling apparatus applied to the mobile terminal 100 includes a display unit; a communication unit configured to form a wireless communication network with an external terminal (or an external peripheral device) when an icon for executing an input interface (e.g., an on-screen keyboard/keypad, a virtual keyboard/keypad/a touch pad, or the like) displayed on the display unit is selected; and a controller configured to change a type of the input interface according to an application executed in the external terminal, and display the changed input interface on the display unit.

The controller selects an input interface interworking with the application from among pre-set input interfaces (e.g., an on-screen keyboard/keypad, a virtual keyboard/keypad/ a touch pad, or the like), and displays the selected input interface on the display unit. For example, the controller selects any one of virtual keyboards or virtual keypads each having a different key array type (form) according to the application operating in the external terminal. The controller may select a touch pad according to an application operating in the external terminal. When the touch pad is touched by a user s finger or a stylus pen, the controller moves a cursor or a point of the external terminal based on the touched position.

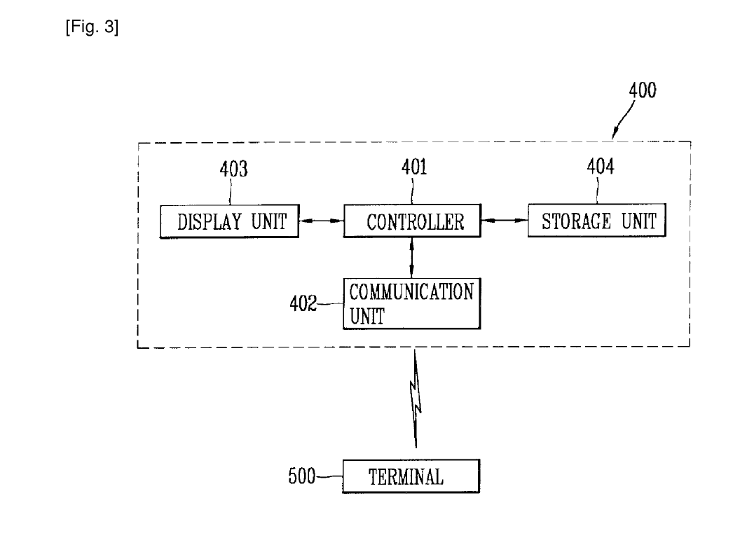

A detailed description of elements of the input interface controlling apparatus applied to the mobile communication terminal 100 according to embodiments of the present invention will be described with reference to FIGS. 3 to 10.

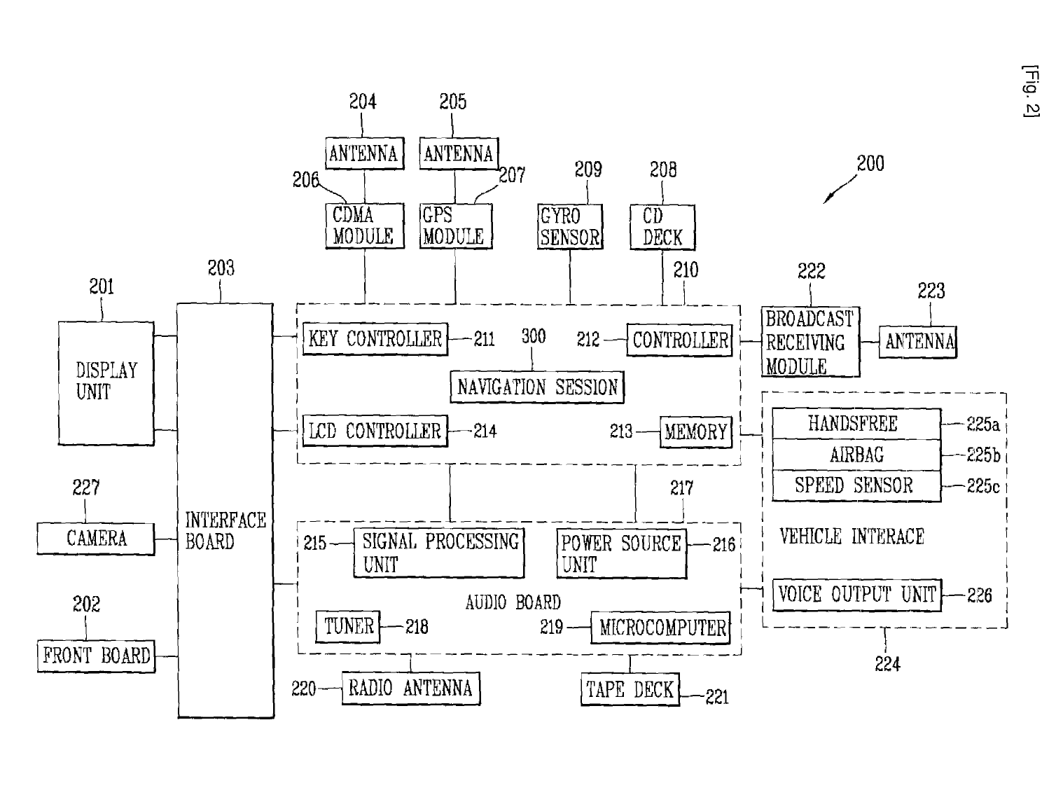

The configuration of a telematics terminal 200 employing the input interface controlling apparatus according to an exemplary embodiment of the present invention will now be described with reference to FIG. 2.

FIG. 2 is a schematic block diagram showing the telematics terminal 200 employing the input interface controlling apparatus according to an exemplary embodiment of the present invention.

As shown in FIG. 2, the telematics terminal 200 includes a main board 210 including a controller (e.g., a central processing unit (CPU)) 212 for controlling the telematics terminal 200 on the whole, a memory 213 for storing various types of information, a key controller 211 for controlling various key signals, and an LCD controller 214 for controlling an LCD.

The memory 213 stores map information (map data) for displaying road guidance information on a digital map. Also, the memory 213 stores a traffic information collecting control algorithm for inputting traffic information according to the situation of a road along which the vehicle currently travels (runs), and information for controlling the algorithm.

The main board 210 includes a CDMA module 206, a mobile terminal having a unique device number as assigned and installed in the vehicle, a GPS module 207 for guiding a location of the vehicle, receiving a GPS signal for tracking a travel route from a start point to a destination, or transmitting traffic information collected by the user, as a GPS signal, a CD deck 208 for reproducing a signal recorded in a CD (Compact Disk), a gyro sensor 209, or the like. The CDMA module 206 and the GPS module 207 receive signals via antennas 204 and 205.

A broadcast receiving module 222 is connected with the main board 210 and receives a TV signal via a TV antenna 223. A display unit (i.e., an LCD) 201 under the control of the LCD controller 214, a front board 202 under the control of the key controller 211, and a camera 227 for capturing the interior and/or the exterior of a vehicle are connected to the main board 210 via an interface board 203. The display unit 201 displays various video signals and character signals, and the front board 202 includes buttons for various key signal inputs and provides a key signal corresponding to a button selected by the user to the main board 210. Also, the display unit 201 includes a proximity sensor and a touch sensor (touch screen) of FIG. 2.

The front board 202 includes a menu key for directly inputting traffic information. The menu key may be configured to be controlled by the key controller 211.

An audio board 217 is connected with the main board 210 and processes various audio signals. The audio board 217 includes a microcomputer 219 for controlling the audio board 217, a tuner 218 for receiving a radio signal, a power source unit 216 for supplying power to the microcomputer 219 and a signal processing unit 215 for processing various voice signals.

The audio board 217 also includes a radio antenna 220 for receiving a radio signal and a tape deck 221 for reproduce an audio tape. The audio board 217 may further include a voice output unit (e.g., an amplifier) 226 for outputting a voice signal processed by the audio board 217.

The voice output unit (amplifier) 226 is connected to a vehicle interface 224. Namely, the audio board 217 and the main board 210 are connected to the vehicle interface 224. A handsfree 225a for inputting a voice signal, an airbag 225b configured for the security of a passenger, a speed sensor 225c for detecting the speed of the vehicle, or the like, may be connected to the vehicle interface 224. The speed sensor 225c calculates a vehicle speed and provides the calculated vehicle speed information to the CPU 212.

The navigation session 300 applied to the telematics terminal 200 generates road guidance information based on the map data and current location information of the vehicle and provides the generated road guidance information to a user.

The display unit 201 detects a proximity touch within a display window via a proximity sensor. For example, when a pointer (e.g., user s finger or stylus) is proximity-touched, the display unit 201 detects the position of the proximity touch and outputs position information corresponding to the detected position to the controller 212.

A voice recognition device (or a voice recognition module) 301 recognizes a voice pronounced by the user and performs a corresponding function according to the recognized voice signal.

The navigation session 300 applied to the telematics terminal displays a current location and a travel route on map data.

Meanwhile, the input interface controlling apparatus applied to the telematics terminal 200 according to an exemplary embodiment of the present invention may includes: a display unit; a communication unit configured to form a wireless communication network with an external terminal (or an external peripheral device) when an icon for executing an input interface (e.g., an on-screen keyboard/keypad, a virtual keyboard/keypad/a touch pad, or the like) displayed on the display unit is selected; and a controller configured to change a type of the input interface according to an application executed in the external terminal, and display the changed input interface on the display unit.

The controller selects an input interface interworking with the application from among pre-set input interfaces (e.g., an on-screen keyboard/keypad, a virtual keyboard/keypad/a touch pad, or the like), and displays the selected input interface on the display unit. For example, the controller selects any one of virtual keyboards or virtual keypads each having a different key array type (form) according to the application operating in the external terminal. The controller may select a touch pad according to an application operating in the external terminal. When the touch pad is touched by a user s finger or a stylus pen, the controller moves a cursor or a point of the external terminal based on the touched position.

Hereinafter, an input interface controlling apparatus and method thereof according to embodiments of the present invention will now be described with reference to FIGS. 3 to 10. The input interface controlling apparatus and method thereof according to embodiments of the present invention can be applicable to a terminal such as smart phones, notebook computers, PDAs (Personal Digital Assistants), PMPs (Portable Multimedia Player), etc, as well as to the mobile terminals such as the mobile communication terminal 100, the telematics terminal 200, a navigation device, or the like.

FIG. 3 is a view showing the configuration of an input interface controlling apparatus according to an embodiment of the present invention.

As shown in FIG. 3, an input interface controlling apparatus 400 of a mobile terminal (e.g., the mobile communication terminal 100) according to an embodiment of the present invention includes a display unit 403; a communication unit 402 configured to form a wireless communication network with an external terminal (or an external peripheral device) 500 when an icon for executing an input interface (e.g., an on-screen keyboard/keypad, a virtual keyboard/keypad/a touch pad, or the like) displayed on the display unit 403 is selected; and a controller 401 configured to change a type of the input interface according to an application executed in the external terminal 500, and display the changed input interface on the display unit 403.

The controller 401 selects an input interface interworking with the application from among pre-set input interfaces (e.g., an on-screen keyboard/keypad, a virtual keyboard/keypad/ a touch pad, or the like), and displays the selected input interface on the display unit 403. For example, the controller 401 selects any one of virtual keyboards or virtual keypads each having a different key array type (form) according to the application operating in the external terminal 500. The controller 401 may select a touch pad according to an application operating in the external terminal 500. When the touch pad is touched by a user's finger or a stylus pen, the controller 401 moves a cursor or a point of the external terminal 500 based on the touched position.

The input interface controlling apparatus 400 includes a storage unit 404 storing virtual keyboards each having a different key array type (form), virtual keypads each having a different key array type, a keyboard or touch pad execution application (application program), various types of data such as documents, photographs, video, and the like. The virtual keyboards or keypads may be a Qwerty keyboard or keypad, a half-Qwerty keyboard or keypad, a keyboard or keypad displaying only number keys.

The external terminal 500 requests an input interface (e.g., any one of a virtual keyboard, a keypad displaying only numbers, and a touch pad) interworking with the application from the controller 401 through the wireless communication network, and the controller 401 displays (or applies) the input interface interworking with the application on (or to) the display unit 403.

When a search window (or an address input window) of the Web browser (application) is displayed on the external terminal 500, the controller 401 may select an input interface (e.g., a Qwerty keyboard or keypad) allowing for inputting of a search word to the search window (or the address input window) and display the selected input interface on the display unit 403.

When a number input window (e.g., an input of a resident registration number, an input of date, etc.) of a Web browser is displayed on the external terminal 500, the controller 401 may select an input interface (e.g., a keyboard displaying only number keys or a number keypad) allowing for inputting of numbers to the number input window, and display the selected input interface (e.g., the keyboard displaying only number keys or the number keypad) on the display unit 403.

When a broadcast channel number input window is displayed on the external terminal 500, the controller 401 may select an input interface (e.g., the keyboard displaying only number keys or the number keypad) allowing for inputting of numbers to the broadcast channel input window and display the selected input interface (e.g., the keyboard displaying only number keys or the number keypad) on the display unit 403.

When a Web browser is displayed on the external terminal 500, the controller 401 may select an input interface (e.g., a touch pad) allowing for selecting or executing of content of the Web browser and display (or apply) the selected input interface on (or to) the display unit 403. Namely, the controller 401 changes an input mode of the display unit 403 into a touch pad mode. Here, in response to a touch pad change request, the controller 401 may change the input mode of the display unit 403 into the touch pad and synchronize the changed touch pad with the external terminal 500, whereby the user can control the external terminal 500 while moving a pointer (or a cursor) through the touch pad. For example, the user may select or execute content of a Web browser displayed on the screen of the external terminal 500 through the touch pad.

When a particular key of the displayed input face is selected, the controller 401 may transmit key information (key data) corresponding to the selected particular key to the external terminal 500.

The controller 401 may also control the external terminal 500 according to an input interface scheme such as a magic motion remote controller using a gravity sensor (not shown).

The external terminal 500 may be a vehicle terminal, a television, a telematics terminal, a PMP, a PDA, or the like.

The controller 401 may form a wireless communication network (e.g., a Wi-Fi communication network, a Bluetooth communication network, or the like) with the external terminal 500.

The communication unit 402 may include a Wi-Fi module, a Bluetooth™ module, Radio Frequency IDentification (RFID) module, an Infrared Data Association (IrDA) module, an Ultra-WideBand (UWB) module, ZigBee™ module, and the like.

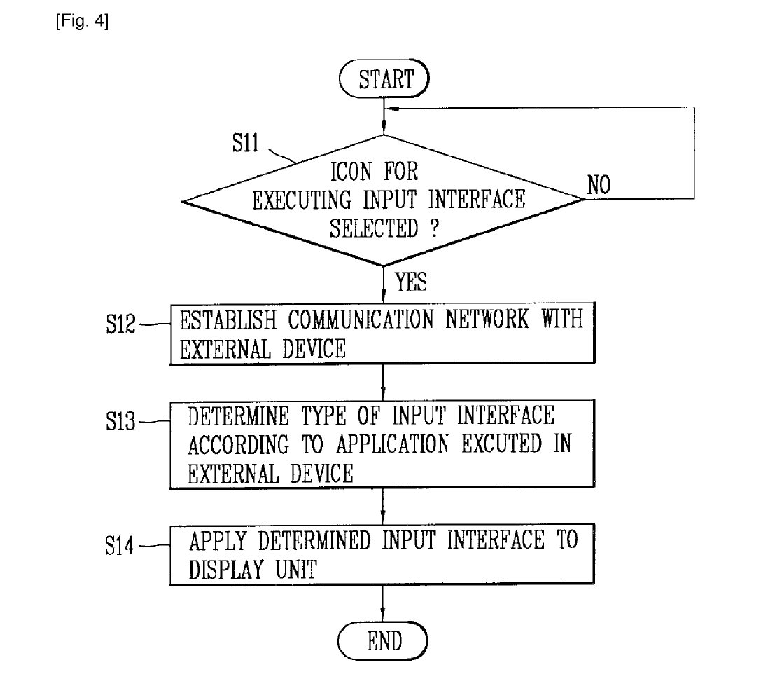

FIG. 4 is a flow chart illustrating a process of a method for controlling an input interface according to an embodiment of the present invention.

First, the controller 401 determines whether or not an icon (e.g., an icon for executing an input interface application) displayed on the display unit 403 is selected by the user (step S11). For example, the controller 401 determines whether or not an icon of an application for executing a keyboard (or keypad) or a touch pad displayed on the display unit 403 has been touched by the user.

When the icon displayed on the display unit 403 is selected, the controller 401 may establish a wireless communication network with the external terminal (or a neighbor terminal) 500 through the communication unit 402 (step S12). The wireless communication network may be a short-range wireless communication network or a wide area wireless communication network.

When the wireless communication network is established with the external terminal (or the neighbor terminal) 500, the controller 401 determines (or changes) a type of an input interface according to an application executed in the external terminal 500 (step S13). For example, when a search window (or an address input window) of the Web browser is displayed on the external terminal 500, the controller 401 may determine an input interface (e.g., a Qwerty keyboard or keypad) allowing for inputting of a search word to the search window (or the address input window), as the input interface. When a number input window (e.g., an input of a resident registration number, an input of date, etc.) of a Web browser is displayed on the external terminal 500, the controller 401 may determine an input interface (e.g., a keyboard displaying only number keys or a number keypad) allowing for inputting of numbers to the number input window, as the input interface. When a broadcast channel number input window is displayed on the external terminal 500, the controller 401 determine an input interface (e.g., the keyboard displaying only number keys or the number keypad) allowing for inputting of numbers to the broadcast channel input window, as the input interface. When a Web browser is displayed on the external terminal 500, the controller 401 may determine an input interface (e.g., a touch pad) allowing for selecting of content of the Web browser, as the input interface.

The controller 401 may determine (or selected) a type of the input interface according to a request from the external terminal 500, or may automatically determine (or select) a type of the input interface according to an application (e.g., an input field of the application) executed in the external terminal 500.

The controller 401 displays the determined (or selected) input interface on the display unit 403 (step S14). For example, when a search window (or an address input window) of the Web browser (application) is displayed on the external terminal 500, the controller 401 may display an input interface (e.g., a Qwerty keyboard or keypad) allowing for inputting of a search word to the search window (or the address input window) on the display unit 403. When a number input window (e.g., an input of a resident registration number, an input of date, etc.) of a Web browser is displayed on the external terminal 500, the controller 401 may display an input interface (e.g., a keyboard displaying only number keys or a number keypad) allowing for inputting of numbers to the number input window on the display unit 403. When a broadcast channel number input window is displayed on the external terminal 500, the controller 401 may display an input interface (e.g., the keyboard displaying only number keys or the number keypad) allowing for inputting of numbers to the broadcast channel input window on the display unit 403. When a Web browser is displayed on the external terminal 500, the controller 401 may display (or apply) an input interface (e.g., a touch pad) allowing for selecting of content of the Web browser on (or to) the display unit 403.

The controller 401 transmits key information (or touch position information) corresponding to a key (or a touched position) selected by the user in the input interface displayed on the display unit 403 to the external terminal 500 through the wireless communication network. Here, the external terminal 500 may perform an operation corresponding to the key information (or the touched position information).

The controller 401 may display an input window along with the input interface (e.g., a keyboard) on the display unit 403, and when a particular key in the displayed keyboard is selected, the controller 401 may display key information (e.g., characters, numbers, symbols, or the like) corresponding to the selected particular key in the input window. When the user selects the particular key from the keyboard displayed on the display unit 403, the controller 401 or the external terminal 500 may also display a search word or a recommended word (or a related word) associated with the selected particular key in the input window.

Accordingly, in the input interface controlling apparatus and method according to embodiments of the present invention, by changing (determining or selecting) a type of the input interface of the second terminal (e.g., a mobile communication terminal) according to an application of the first terminal (e.g., a vehicle terminal, an electronic device such as a television, or the like), the user can quickly and easily input or select (or execute) data to or from (or in) the first terminal through the changed input interface.

In the input interface controlling apparatus and method according to embodiments of the present invention, an input interface of the second terminal (e.g., a mobile communication terminal) is displayed according to an application of the first terminal (e.g., a vehicle terminal, an electronic device such as a television, or the like), and when a particular key of the displayed input interface is selected, a search word, a recommended word (or a related word) associated with the selected particular key, or the like, is detected and displayed, whereby the user can quickly and easily input keys.

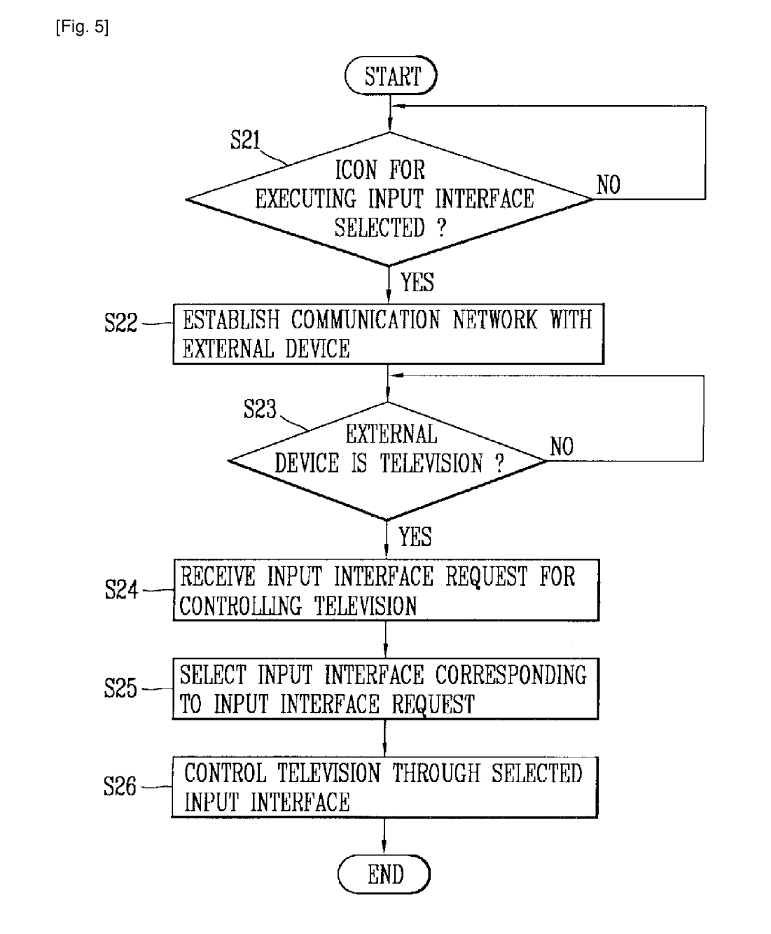

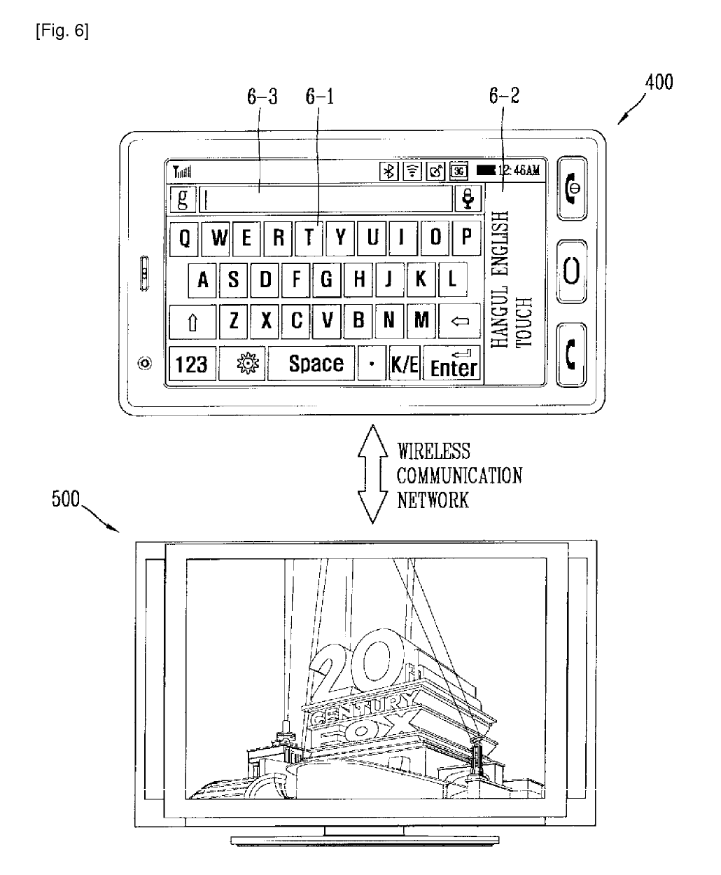

Hereinafter, an input interface controlling apparatus and method capable of changing (determining or selecting) a type of an input interface of the mobile communication terminal 100 according to an application executed in a television (electronic device) to allow the user to quickly and easily control the television through the changed input interface will be described with reference to FIGS. 5 and 6.

FIG. 5 is a flow chart illustrating a process of a method for controlling an input interface according to another embodiment of the present invention.

First, the controller 401 determines whether or not an icon (e.g., an icon for executing an input interface application) displayed on the display unit 403 has been selected by the user (step S21). For example, the controller 401 determines whether or not an icon of an application for executing a keyboard (or keypad) displayed on the display unit 403 has been touched by the user.

When the icon displayed on the display unit 403 is selected, the controller 401 establishes a wireless communication network with the external terminal (or the neighbor terminal) 500 through the communication unit 402 (step S22). The wireless communication network may be a short-range wireless communication network or a wide area wireless communication network.

The controller 401 requests an identifier (a device identifier) (e.g., a device name, a device product number, or the like) from the external terminal 500 through the wireless communication network, and determines whether or not the external terminal 500 is a previously registered television or a previously registered vehicle terminal (e.g., a telematics terminal) based on the identifier of the external terminal 500 (step S23).

When the external terminal (or neighbor terminal) 500 is a television, the controller 401 automatically selects an input interface (e.g., a virtual keyboard/keypad, a touch pad, or the like) for controlling the television 500, or receives an input interface request for controlling the television 500 from the television 500 through the wireless communication network (step S24).

The controller 401 selects an input interface corresponding to the input interface request (step S25). For example, when a Web browser is displayed (or executed) on the television 500, the controller 401 automatically selects an input interface (e.g., a touch pad) for selecting and executing content of the Web browser, or selects it according to a request from the television 500. Meanwhile, when a search window (or an address input window) of the Web browser (application) is displayed on the television 500, the controller 401 may automatically select an input interface (e.g., a Qwerty keyboard or keypad) allowing for inputting of a search word to the search window (or the address input window), or select it according to a request from the television 500. Also, when a broadcast channel number input window is displayed on the television 500, the controller 401 may automatically select an input interface (e.g., the keyboard displaying only number keys or the number keypad) allowing for inputting of numbers to the broadcast channel input window, or select it according to a request from the television 500.

The controller 401 controls the television 500 through the selected input interface (step S28). For example, when a Web browser is executed on the television 500, the controller 401 may apply an input interface (e.g., a touch pad) allowing for controlling (selecting or executing) of content of the Web browser, as an input mode of the display unit 403, to the display unit 403, and control (select or execute) the content of the Web browser of the television 400 according to a touch input (touched position information) of the touch pad.

Meanwhile, when a search window (or an address input window) of a Web browser (application) is displayed on the television 500, the controller 401 may apply an input interface (e.g., a keyboard or a keypad) allowing for inputting of a search word to the search window (or an address input window), as an input mode of the display unit 403, to the display unit 403, and input data (e.g., a search word, an address, or the like) to the search window (or an address input window) of the Web browser of the television 500. When the user selects a particular key from the keyboard applied to the display unit 403, the controller 401 or the external terminal 500 may display a search word or a recommended word (or a related word) associated with the selected particular key in the input window.

When a broadcast channel number input window is displayed on the television 500, the controller 401 may apply an input interface (e.g., the keyboard displaying only number keys or the number keypad) allowing for inputting of numbers to the broadcast channel input window, as an input mode of the display unit 403, to the display unit 403, and input a broadcast channel number to the broadcast channel number input window of the television 500 according to an input of the number keypad.

The controller 401 may request an input interface including a key for controlling an audio volume of the television 500, as well as the input interface for controlling a broadcast channel of the television 500, from the television 500.

FIG. 6 is a view showing an input interface controlling apparatus and a television according to another embodiment of the present invention.

As shown in FIG. 6, when an icon (e.g., an icon for executing an input interface) displayed on the display unit 403 is selected by the user, the input interface controlling apparatus 400 establishes a wireless communication network with the television 500, receives an input interface request signal according to an application executed in the television 500 through the wireless communication network, and displays an input interface (e.g., a keyboard or a keypad) corresponding to the input interface request signal on the display unit 403. The input interface 6-1 may further include a Hangul conversion icon, an English conversion icon, and a touch pad conversion icon (6-2).

In displaying the input interface 6-1 on the display unit 403, the controller 401 may display an input window 6-3 (e.g., a search word input window) along with the input interface 6-1. For example, when a particular key (e.g., a number key, a character key, a symbol key, or the like) on the displayed input interface 6-1 is selected by the user, the controller 401 may display key data corresponding to the selected particular key in the input window 6-3 of the display unit 403.

The controller 401 may change the keyboard into various keyboards such as an English keyboard, a number and/or symbol keyboard, a Hangul keyboard, a French keyboard, and the like.

When the user inputs a search word for searching for broadcast information of broadcast channels through the displayed input interface (e.g., the keyboard), the controller 401 may transmit the search word to the television 500 to search for the broadcast information through the television 500, and display searched broadcast information on the television 500 or display the searched broadcast information on the display unit 403.

Accordingly, in the input interface controlling apparatus and method according to other embodiments of the present invention, by changing (determining or selecting) a type of the input interface of the mobile communication terminal according to an application of the television (or an electronic device), the user can control the television through the changed input interface.

In the input interface controlling apparatus and method according to other embodiments of the present invention, an input interface of the mobile communication terminal is displayed according to an application of the television (or an electronic device), and when a particular key of the displayed input interface is selected, a search word or a recommended word (or a related word) associated with the selected particular key is detected and displayed, so the user can quickly and easily input desired data.

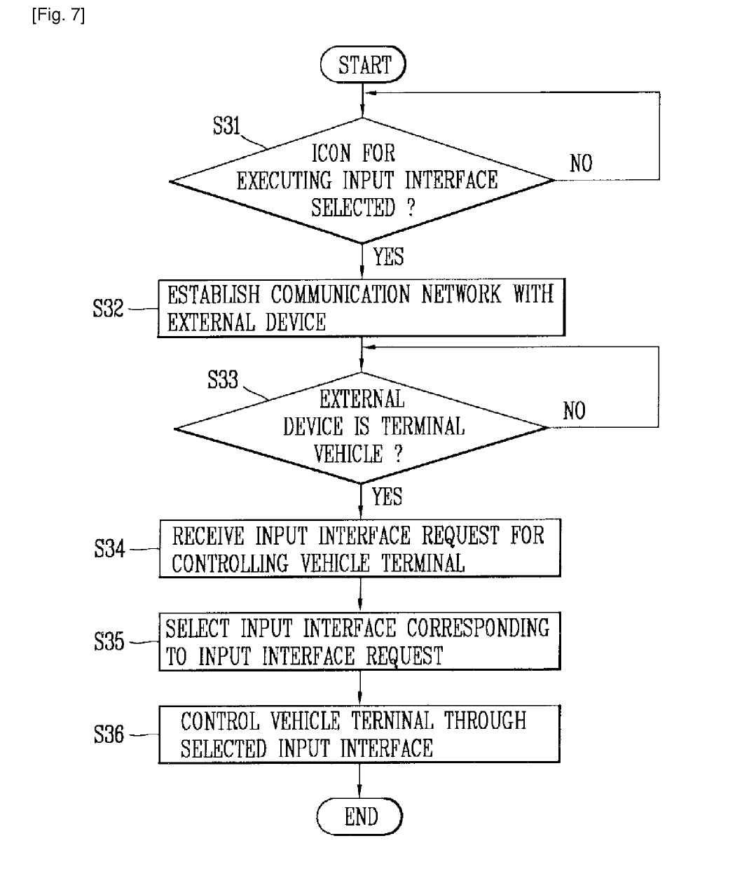

Hereinafter, an input interface controlling apparatus and method of a mobile terminal in which a type of an input interface of the mobile communication terminal 100 is changed according to an application executed in a vehicle terminal (e.g., a telematics terminal), to thereby allow the user to quickly and easily input data (e.g., point of interest (POI) information, destination information, or the like) for controlling the vehicle terminal through the changed input interface will be described with reference to FIGS. 7 to 10.

FIG. 7 is a flow chart illustrating a process of a method for controlling an input interface according to another embodiment of the present invention.

First, the controller 401 determines whether or not an icon (e.g., an icon for executing an input interface application) displayed on the display unit 403 has been selected by the user (step S31). For example, the controller 401 determines whether or not an icon of an application for executing a keyboard (or keypad) displayed on the display unit 403 has been touched by the user.

When the icon displayed on the display unit 403 is selected, the controller 401 establishes a wireless communication network with the external terminal (or the neighbor terminal) 500 through the communication unit 402 (step S32). The wireless communication network may be a short-range wireless communication network or a wide area wireless communication network.

The controller 401 requests an identifier (a device identifier) (e.g., a device name, a device product number, or the like) from the external terminal 500 through the wireless communication network, and determines whether or not the external terminal 500 is a previously registered television or a previously registered vehicle terminal (e.g., a telematics terminal) based on the identifier of the external terminal 500 (step S33).

When the external terminal (or neighbor terminal) 500 is a vehicle terminal (e.g., a telematics terminal), the controller 401 automatically selects an input interface (e.g., a virtual keyboard/keypad, a touch pad, or the like) for controlling the vehicle terminal (e.g., the telematics terminal) 500, or receives an input interface request for controlling the vehicle terminal 500 from the vehicle terminal 500 through the wireless communication network (step S34).

The controller 401 selects an input interface corresponding to the input interface request (step S35). For example, when a map application is displayed on the vehicle terminal 500 (e.g., when a navigation is executed on the vehicle terminal 500), the controller 401 may automatically select an input interface (e.g., a touch pad) for controlling (e.g., selecting/searching for a point of interest (POI), selecting/searching for an area, selecting/executing a navigation menu, or the like) the map application, or select it according to a request from the vehicle terminal 500. Meanwhile, when a search window (e.g., a destination input window, a POI search window, or an address input window) for map searching is displayed on the vehicle terminal 500, the controller 401 may automatically select an input interface (e.g., a Qwerty keyboard or keypad) allowing for inputting a search word to the search window, or select it according to a request from the vehicle terminal 500. Also, when a broadcast channel number input window is displayed on the vehicle terminal 500, the controller 401 may automatically select an input interface (e.g., a keyboard displaying only number keys or a number keypad) allowing for inputting of numbers to the broadcast channel number input window, or select it according to a request from the vehicle terminal 500.

The controller 401 controls the vehicle terminal 500 through the selected input interface (S36). For example, when a navigation is executed in the vehicle terminal 500, the controller 401 may apply an input interface (e.g., a touch pad) for controlling (selecting or executing) menus of the navigation, as an input mode of the display unit 403, to the display unit 403, and select and execute the menus of the navigation of the vehicle terminal 500 according to a touch input (touched position information) of the touch pad.

Meanwhile, when a search window (e.g., a destination input window, a POI search window, or an address input window) for map searching is displayed on the vehicle terminal 500, the controller 401 may apply an input interface (e.g., a keyboard or keypad) allowing for inputting of a search word to the search window, as an input mode of the display unit 403, to the display unit 403, and input data (e.g., a search word, an address, or the like) to the search word (e.g., the destination input window, the POI search window, or the address input window) of the vehicle terminal 500. When the user selects a particular key from the input interface (e.g., the keyboard) applied to the display unit 403, the controller 401 or the vehicle terminal 500 may display a search word or a recommended word (or a related word) associated with the selected particular key in the input window.

When a broadcast channel number input window is displayed on the vehicle terminal 500, the controller 401 may apply an input interface (e.g., the keyboard displaying only number keys or the number keypad) allowing for inputting of numbers to the broadcast channel input window, as an input mode of the display unit 403, to the display unit 403, and input a broadcast channel number to the broadcast channel number input window of the vehicle terminal 500 according to an input of the number keypad.

The controller 401 may request an input interface including a key for controlling an audio volume of the vehicle terminal 500, as well as the input interface for controlling a broadcast channel of the vehicle terminal 500, from the vehicle terminal 500.

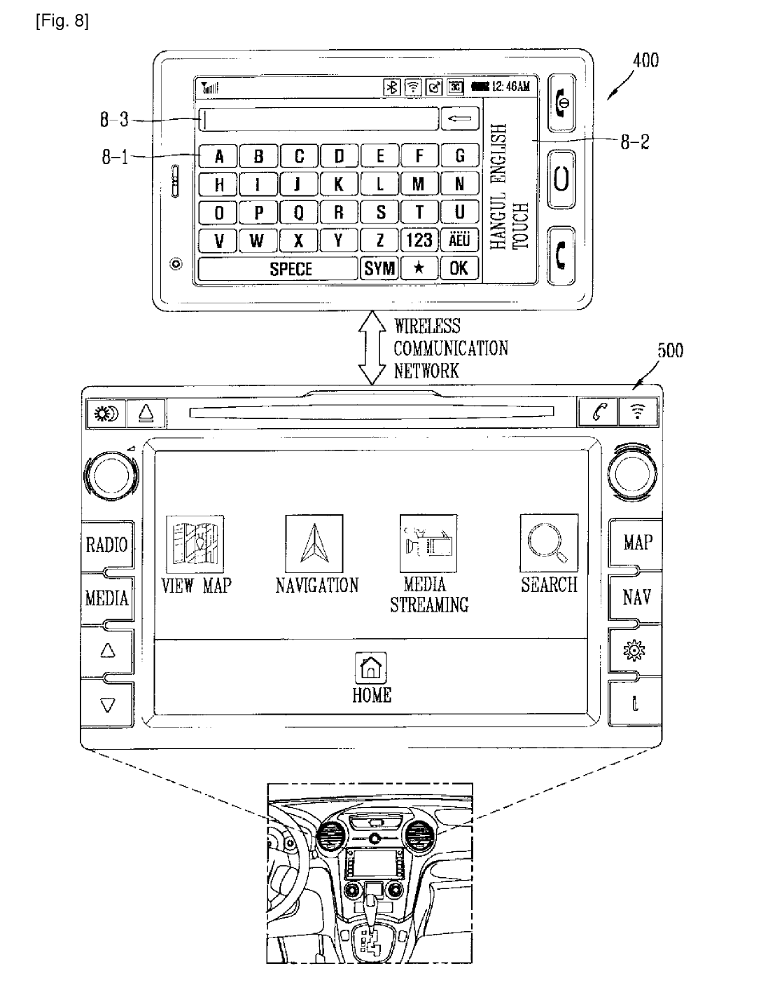

FIG. 8 is a view showing an input interface controlling apparatus and a vehicle terminal according to another embodiment of the present invention.

As shown in FIG. 8, when an icon (e.g., an icon for executing an input interface) displayed on the display unit 403 is selected by the user, the input interface controlling apparatus 400 establishes a wireless communication network with the vehicle terminal 500, receives an input interface request signal from the vehicle terminal 500 through the wireless communication network, selects an input interface corresponding to the received input interface request signal, and displays the selected input interface (e.g., a virtual keyboard) 8-1 on the display unit 403. The virtual keyboard 8-1 may further include a Hangul conversion icon, an English conversion icon, and a touch pad conversion icon (8-2).

In displaying the virtual keyboard 8-1 on the display unit 403, the controller 401 may display an input window 8-3 (e.g., a search word input window) along with the virtual keyboard 8-1. For example, when a particular key (e.g., a number key, a character key, a symbol key, or the like) on the displayed virtual keyboard 8-1 is selected by the user, the controller 401 may display key data corresponding to the selected particular key in the input window 8-3 of the display unit 403.

When, a particular key of the keyboard displayed on the display unit 403 is selected by the user, the controller 401 transmits key information corresponding to the selected particular key to the vehicle terminal 500 through the wireless communication network. For example, when a particular key is selected by the user from the virtual keyboard displayed on the display unit 403, the controller 401 may transmit key information corresponding to the selected key, as destination information or a POI search word, to the vehicle terminal 500. Then, the vehicle terminal 500 may search a destination or a POI according to the destination information or the POI search word, and display the search results.

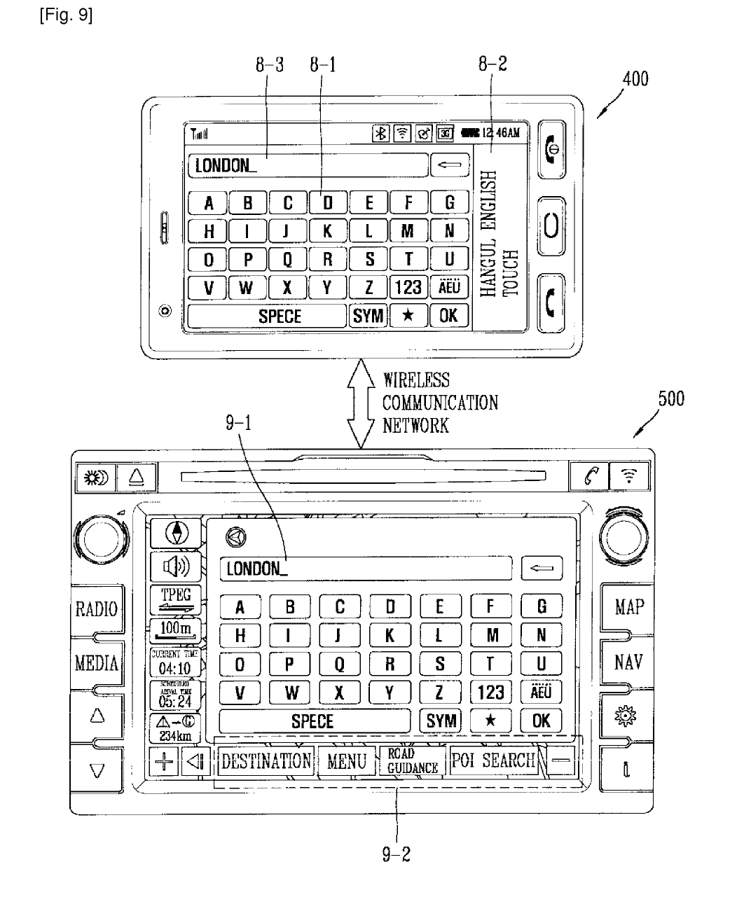

FIG. 9 is a view showing information regarding a point of interest (POI) displayed on the vehicle terminal according to another embodiment of the present invention.

As shown in FIG. 9, when the POI search word is received from the controller 401 through the wireless communication network, the vehicle terminal 500 may display the received POI search word (e.g., LONDON) in an input window 9-1, and search for POIs associated with the POI search word. The vehicle terminal 500 may transmit a navigation menu (e.g., a navigation menu including a destination, road guidance, POI search, or the like) along with the virtual keyboard to the controller 401 through the wireless communication network.

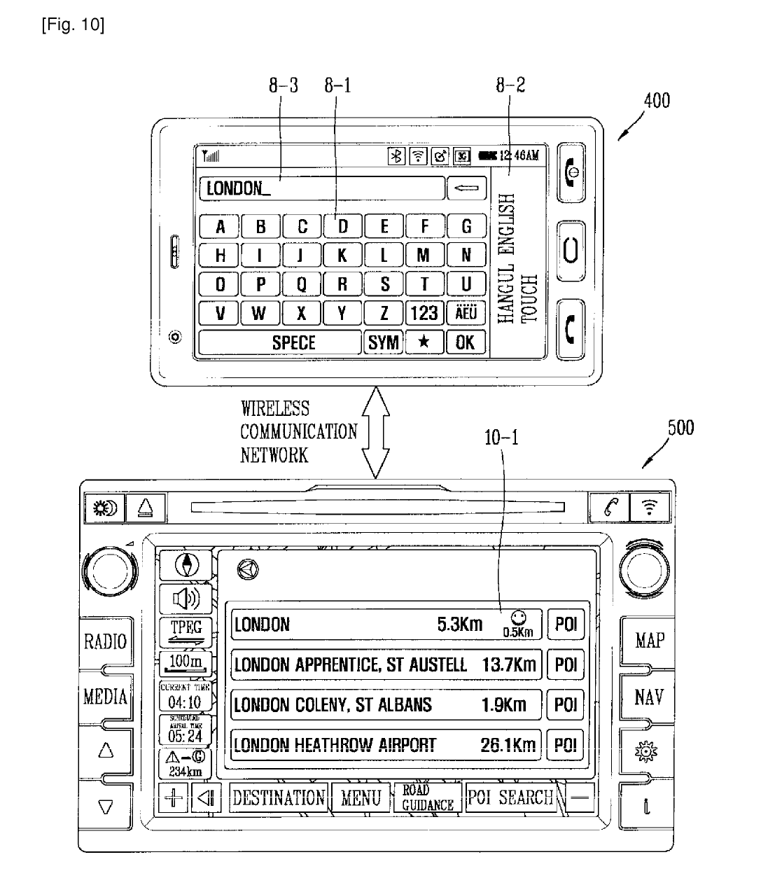

FIG. 10 is a view showing the POI search results displayed on the vehicle terminal according to another embodiment of the present invention.

As shown in FIG. 10, when the POI search word is received from the controller 401 through the wireless communication network, the vehicle terminal 500 may display the received POI search word (e.g., LONDON) in the input window 9-1, search for POIs associated with the POI search word, and display a list including the searched POI results 10-1 on the display unit 403.

When the particular key is selected by the user from the keyboard displayed on the display unit 403, the controller 401 or the vehicle terminal 500 may display a search word or a recommended word associated with the selected particular key in the input window.

When the user inputs a search word for searching for broadcast information of broadcast channels through the displayed keyboard, the controller 401 may transmit the search word to the vehicle terminal 500 to search for the broadcast information through the vehicle terminal 500 and display the searched broadcast information on the vehicle terminal 500 or on the display unit 403.

Accordingly, in the input interface controlling apparatus and method according to other embodiments of the present invention, by changing (determining or selecting) a type of an input interface of the mobile communication terminal according to an application of the vehicle terminal (or an electronic device), the user can quickly and easily control the vehicle terminal through the changed input interface.

In the input interface controlling apparatus and method according to other embodiments of the present invention, an input interface of the mobile communication terminal is displayed according to an application of the vehicle terminal (or an electronic device), and when a particular key of the displayed input interface is selected, a search word or a recommended word associated with the selected particular key is detected and displayed. Thus, the user can quickly and easily input desired data.

As described above, in the apparatus for controlling an input interface of a mobile terminal and the method thereof according to embodiments of the present invention, since a type of an input interface of a second terminal (e.g., a mobile communication terminal) is changed according to an application of a first terminal (e.g., a vehicle terminal, an electronic device such as a television, or the like), the user can easily input or select (or execute) data through the changed input interface.

Also, in the apparatus for controlling an input interface of a mobile terminal and the method thereof according to embodiments of the present invention, the input interface of the second terminal (e.g., a mobile communication terminal) is displayed according to an application of the first terminal (e.g., a vehicle terminal, an electronic device such as a television, or the like), and when a particular key of the displayed input interface is selected, a search word, a recommended word, or the like, related to the selected particular key is detected and displayed, the user can quickly and easily input keys.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. An input interface controlling apparatus comprising:
a display unit;
a communication unit configured to form a wireless communication network with an external terminal when an icon for executing an input interface displayed on the display unit is selected; and
a controller configured to select a type of the input interface according to an application executed in the external terminal, and display an input interface of the selected type on the display unit.

2. The apparatus of claim 1, wherein the controller selects any one of a virtual keyboard, a virtual keypad, and a touch pad, as the input interface based on the application executed in the external terminal.

3. The apparatus of claim 1, wherein the controller receives a request for an input interface interworking with the application from the external terminal through the wireless communication network, selects the input interface interworking with the application according to the received input interface request, and applies the selected input interface to the display unit.

4. The apparatus of claim 1, wherein the controller selects a type of the input interface based on a type of an input window displayed on the external terminal by the application.

5. The apparatus of claim 1, wherein the controller controls the application according to an input of the selected input interface.

6. The apparatus of claim 1, wherein the controller displays an input window along with the input interface on the display unit, and when a key of the input interface is selected, the controller displays key information corresponding to the selected key on the input window.

7. The apparatus of claim 6, wherein the controller receives a search word or a related word associated with the key information from the external terminal through the wireless communication network, and display the received search word or the related word on the input window.

8. The apparatus of claim 1, wherein when a Web browser or a map application is executed in the external terminal, the controller automatically displays a touch pad or a virtual keyboard on the display unit.

9. The apparatus of claim 1, wherein when a number input window is displayed on the external terminal, the controller selects a number keypad or a keyboard displaying only numbers, and displays the selected number keypad or the keyboard displaying only numbers.

10. The apparatus of claim 1, wherein when the application is executed in the external terminal, the controller automatically selects a virtual keyboard or a touch pad for controlling the application, and applies the selected virtual keyboard or the touch pad as the input interface on the display unit.

11. A method for controlling an input interface, the method comprising:
when an icon for executing a input interface displayed on a display unit, forming a wireless communication network with an external terminal;
selecting a type of the input interface according to an application executed in the external terminal; and
displaying the selected type of the input interface on the display unit.

12. The method of claim 11, wherein, in selecting a type of the input interface, any one of a virtual keyboard, a virtual keypad, and a touch pad is selected as the input interface based on the application executed in the external terminal.

13. The method of claim 11, wherein the selecting of a type of the input interface comprises:
receiving a request for an input interface interworking with the application from the external terminal through the wireless communication network;
selecting the input interface interworking with the application according to the received input interface request; and
applying the selected input interface to the display unit.

14. The method of claim 11, wherein the selecting of a type of the input interface comprises:
selecting a type of the input interface based on a type of an input window displayed on the external terminal by the application.

15. The method of claim 11, further comprising:
controlling the application according to an input of the selected input interface.

16. The method of claim 11, further comprising:
displaying an input window along with the input interface on the display unit; and
when a key of the input interface is selected, displaying key information corresponding to the selected key on the input window.

17. The method of claim 16, further comprising:
receiving a search word or a related word associated with the key information from the external terminal through the wireless communication network; and
displaying the received search word or the related word on the input window.

18. The method of claim 11, wherein the displaying of the input interface on the display unit comprises:
when a Web browser or a map application is executed in the external terminal, automatically displaying a touch pad or a virtual keyboard on the display unit.

19. The method of claim 11, wherein the displaying of the input interface on the display unit comprises:
when a number input window is displayed on the external terminal, selecting a number keypad or a keyboard displaying only numbers; and
displaying the selected number keypad or the keyboard displaying only numbers.

20. The method of claim 11, wherein the displaying of the input interface on the display unit comprises:
when the application is executed in the external terminal, automatically selecting a virtual keyboard or a touch pad for controlling the application; and
applying the selected virtual keyboard or the touch pad as the input interface on the display unit.
